(19) United States
(12) Patent Application Publication
(10) Pub. No.: US 2011/0270807 A1
(43) Pub. Date: Nov. 3, 2011

(54) Method In A Database Server

(76) Inventors: Susana Gomez Maturana, Madrid (ES); Maria Pilar González López, Madrid (ES); Stefan Pudas, Thatcham (GB); Stephen Terrill, Villanueva de la Cañada (ES)

(21) Appl. No.: 13/142,629

(22) PCT Filed: Dec. 30, 2008
(86) PCT No.: PCT/EP2008/068351

§ 371 Date: Jun. 29, 2011

(51) Int. Cl. G06F 17/30

(52) U.S. Cl. 707/690; 707/E17.005

(57) ABSTRACT

Method, apparatus and computer program for storing by a database server a plurality of data entries containing data related to a plurality of applications. The database server receives a request to modify the content of a data entry and checks a validation rule related to the entry before performing the modification. The validation rule contains information usable for determining valid data contents that can be stored in said entry, and information for building the validation rule is received from one or more application servers serving said applications. When a back end database server system stores data related to a plurality of applications, data validation check mechanisms are simplified, as information for performing validity checks are received from the application servers in the database system.

### FIELD OF THE INVENTION

The present invention relates to methods, apparatus and computer program for storing by a database server a plurality of data entries containing data related to a plurality of applications.

### BACKGROUND

Traditionally, information and telecommunications services have been offered based on the use of monolithic servers. The term monolithic server refers to a kind of server comprising processing logic and data storage capabilities that allows it to process the signaling it can receive, as well as the signaling to be sent, by using data it stores internally. In other words, a monolithic server is arranged to serve a certain service by using its internal processing and storage means.

Data consistency on data modifications over data entries storing data held by a monolithic server is guaranteed by—say—hard coded procedures in the server, which are related to the specific service(s) it serve, and which use to be fully integrated within the means implementing the service logic. For example, in a computer based server, these procedures are commonly embedded within the software implementing the service logic, and are arranged to e.g. verify that a certain data is within a given range and/or that said data can be modified only upon certain circumstances (e.g. depending on the value of some other data).

Data modification of a given data entry comprises e.g.: adding data content for said data entry (e.g. even creating data entry attributes and/or new contents), deletion of its contents, and change of its contents. Data modification of a given data entry held by a server can take place as a result of the normal operation of the server (e.g. a data is modified as a result of a service execution), or due to provisioning operations (e.g. an operation and maintenance server sets/deletes/modifies some data in the server).

However, factors such as, among others, scalability, performance or deployment/implementation cost, are starting to drive towards another kind of solution, wherein the functionality provided by some monolithic servers is—say—“tiered” resulting into a layered architecture. The principle behind this kind of solution consists on decoupling the service logic processing from the mere data storage.

A layered architecture comprises, in essence: a plurality of application servers acting as service processing front-ends FEs, and a database server DBS acting as a back-end storage system. In short, a FE comprises the necessary signaling and processing means for serving some specific application service(s), while the DBS merely stores the data that can be needed by the FEs for providing the service(s) they respectively serve. Depending on factors, such as: the amount of data to be stored, access availability, data distribution policies, etc; the DBS can comprise one database, or a plurality of databases DB (e.g. implemented along separated machines). Also, depending on implementation factors, some data can be replicated in more than one DB, wherein mechanisms internal to the DBS can take care of the relevant copies.

An advantage underlying a data layered architecture implementation is that it makes possible to use commercially available robust DBS products, acting as back-end storage, rather than devising costly proprietary (monolithic) products having to cope with, both: high signaling processing capabilities and high capacity/resiliency in what regards to data storage capabilities. For example, in telecommunications systems, some telecommunications nodes which are being envisaged so as to be adapted according to a layered architecture are, among others: Home Location Registers HLR, Home Subscriber Servers HSS, Device Configuration Registers DCR (e.g. as described in patent application WO 03/096724 A1), Policy Controllers (e.g. such as a Policy and Charging Rules Function PCRF as described in 3GPP Specification TS 23.203 V8.2.0, June-2008), Authorization and Authentication servers AAA, SIP (Session Initiation Protocol) telephony application servers for serving specific services to users of an Internet Protocol Multimedia Subsystem, IMS (e.g. such as SIP-AS as described on 3GPP specification TS 23.228 V8.6.0, Sep-2008), and messaging application servers for serving short message service, SMS, or multimedia message service MMS.

These nodes, cited as examples, as well as other kind of application servers, in monolithic implementations, hold and store internally data entries storing data related to, e.g., a plurality of users so as to accomplish with the service(s) they serve for these users. In certain cases, some of these data can be similar, or even equal, for different applications.

Manufacturers and service providers, not necessarily limited to telecom manufacturers and telecom operators, can benefit from a layered architecture implementation, wherein some/all of the data related to a plurality of applications are stored in a DBS, which is commonly accessible to the servers serving said plurality of applications. This allows devising/operating less complex application servers, as they are not required to have high capacity/resiliency in what regards to data storage capabilities, and allows the use of commercially available DBS products, so as to reduce costs.

In this kind of scenarios, some of the data stored in the DBS can be shared by more than one application, so that e.g. a given data entry in the DBS can be adapted to store data related to a first and a second application, wherein these applications can send requests to access and/or modify to the content of said data entry. This data sharing feature can provide the further advantage of reducing the total storage capability and, thus, contribute to decrease the final costs. However, data consistency can be an issue, which can increase the development or adaptation costs of the application servers and/or of the DBS, when more than one server share a certain data that they do not store and hold locally, but that is stored in a back-end DBS, and can be held (e.g. accessed/used/modified) by another entity.

### SUMMARY

It is an object of the present invention to provide a solution for ensuring data consistency in scenarios comprising a plurality of servers serving a plurality of applications, and a database server storing data related to these applications, which minimizes impact on development costs.

Aspects of the invention relate to a method, a database server, and a computer program product, as claimed in the independent claims. Embodiments of the invention are set out in the dependent claims.

When the database server receives a request to modify the content of a data entry, it checks a validation rule related to the entry before performing the modification. The validation rule contains information usable for determining valid data contents that can be stored in said entry. The information for building the validation rule is received from one or more application servers serving the applications, or from an operation and maintenance server provisioning data for said applications.

In situations wherein a back end database server system stores data related to a plurality of applications, data validation check mechanisms are simplified, as information for performing validity checks is received in the database server from the application servers. Design or adaptation impacts in the database server are thus minimized.

### BRIEF DESCRIPTION OF THE DRAWINGS

FIG. 1 shows a schematic illustration of a system according to an embodiment of the invention comprising: a database server, a plurality of servers serving different applications, and an operation and maintenance server.

FIG. 2 illustrates allocation of control and enforcement functions for data validations according to one embodiment of the invention.

FIGS. 3 and 4 illustrate methods according to embodiments of the invention.

FIG. 5 shows a schematic representation of some functional modules of a database server according to one embodiment of the invention.

### DETAILED DESCRIPTION

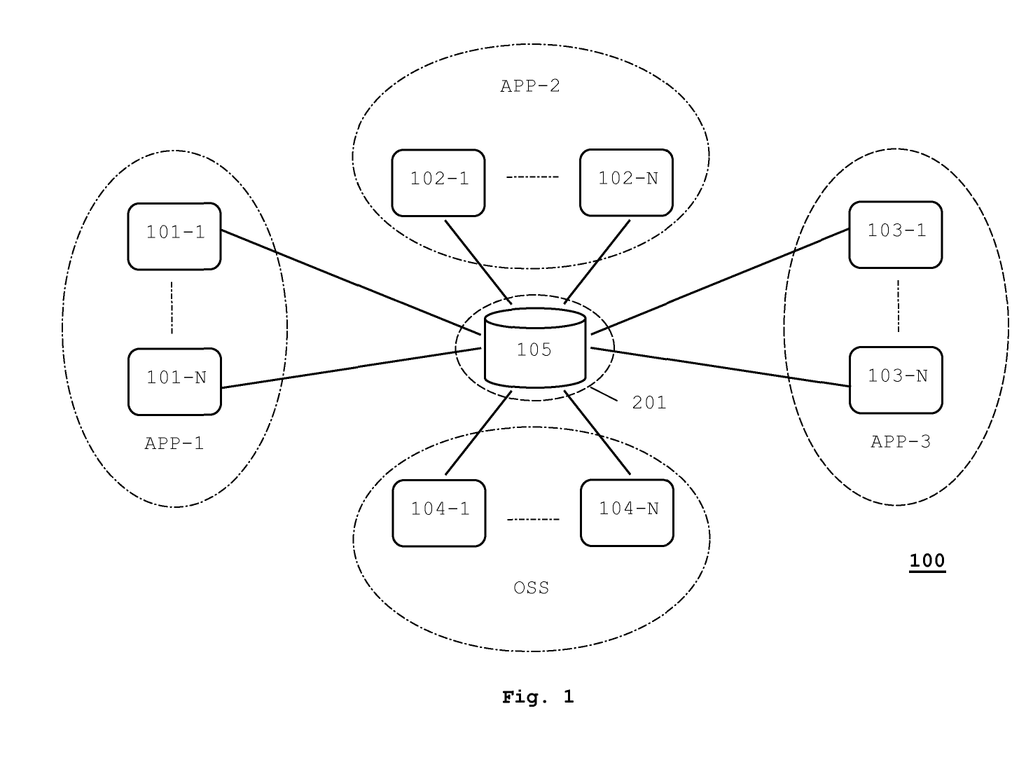

Exemplary embodiments of the invention shall now be described with reference to FIGS. 1 to 5.

The system of FIG. 1 illustrates schematically: a plurality of servers (101, 102, 103) serving a plurality of applications (APP-1, APP-2, APP-3), an operation and maintenance subsystem (OSS) comprising operation and maintenance servers (104), and a database server DBS 105. In the illustrated system 100, the DBS 105 stores at least part of the data that are needed by some of the servers 101 to 103 for accomplishing with the service(s) they respectively provide. In turn, servers 104 perform provisioning tasks to manage data in the DBS 105, some of which shall be later detailed.

The number of users of telecommunications and information systems, as well as the traffic signaling and processing load due to these users, trend to continuously grow. These facts cause the operators owning these systems to demand solutions offering more performance, capacity and, at the same time, scalability. As described earlier, a layered architecture can be a solution for these kinds of demands, wherein the processing logic and the mere data storage is, respectively, divided among signaling FEs and back-end storage DBS.

For the sake of illustration, the system 100 can be assumed to represent part of a telecommunications system, wherein, as cited earlier, some of its nodes and specific servers have been adapted according to a layered architecture. However, features of the invention are equally applicable to other kind of scenarios comprising a back-end storage system (DBS, 105) storing data related to a plurality of applications, and a plurality of servers serving said applications which store and access to data in the DBS.

For example: HSS applications can be implemented by servers 101-1 to 101-N. In turn, servers 102-1 to 102-N can be SIP-AS implementing service logic for high-level call treatment of multimedia calls established between users trough a IMS system of system 100 (for the sake of simplicity, other entities/nodes of the IMS system, or other entities/nodes of the telecommunication system, are not represented in FIG. 1). Handling of messaging services, such as short messages SMS or multimedia messages MMS, can be assumed to be performed by servers 103-1 to 103-N. Servers 104-1 to 104-N can be arranged to perform operation and maintenance tasks for the telecommunications system 100. For example, any of the servers 104 can be part of an Operations Support System OSS of a telecom operator and, e.g., arranged to perform, among other, functions such as data provisioning (e.g. setting of user data at subscription creation or change, setting of specific service data for users at service adscription or change, etc) and reporting. The database server 105 can offer standardized access interfaces 201 according to one or more protocols. For example, the Lightweight Directory Access Protocol LDAP (IETF RFC 4511, June 2006) allows any of the servers serving any of said applications (APP-1, APP-2, APP-3, OSS) to modify and/or obtain data stored in data entries of the DBS 105 by sending the appropriate messages to the DBS 105 addressing the concerned data. Other protocols can be used in the interface 201 for accomplishing with embodiments of the invention, as will be later referred.

It is to be noticed that the example illustrated by FIG. 1 displays a specific case wherein all the servers serving the applications (servers 101, 102, 103), as well as the servers performing operation and maintenance tasks (servers 104), are represented as having a plurality of replicated processing front-ends (e.g. 101-1 to 101-N, 102-1 to 102-N, etc). However, this is just a possible realization, and other possible ones are equally valid, without affecting features of the invention, wherein, for example, some (or all) applications or maintenance functions are accomplished by single servers (e.g. application APP-1 served by server 101, application APP-2 served by server 102, etc).

In the scenario described so far, some of the data stored in the DBS can be shared by more than one application. Examples of shared data can be: user identifier(s) related to some users, service subscription data for some services of these users, connection status of these users, positioning information of these users, etc. In this case, a given data entry in the DBS can be adapted to store data usable by two or more of the applications APP-1, APP-2 or APP-3; and the servers serving said applications (101, 102, 103), as well as the operation and maintenance servers performing data provisioning (104), can address said data entry so as to modify it and/or to obtain its contents. This sharing feature, as provided by a common back-end storage DBS 105 helps to save storage capacity, and further allows devising services, the execution of which can e.g. be conditioned by information related to other services.

However this brings about the problem of data consistency/integrity between different application services. Namely, when the content of a certain data entry is related to more than one application, a modification of said content made by a first server serving a first application service, e.g. as a result of a service execution, can affect service execution of another service by a second server. Fixing this issue in such a layered scenario is not trivial.

For example, a first server (102-1) serving a first application (APP-2) would need to implement (e.g. hard coded) part of the service logic of a second server (103-1) serving a second application, and vice versa, so as to ensure data consistency among them about any data related to both that is stored in the back-end storage 105. Alternatively, the DBS 105 could be designed with hard coded procedures (as described earlier) considering all particularities of all the applications for which it could store data.

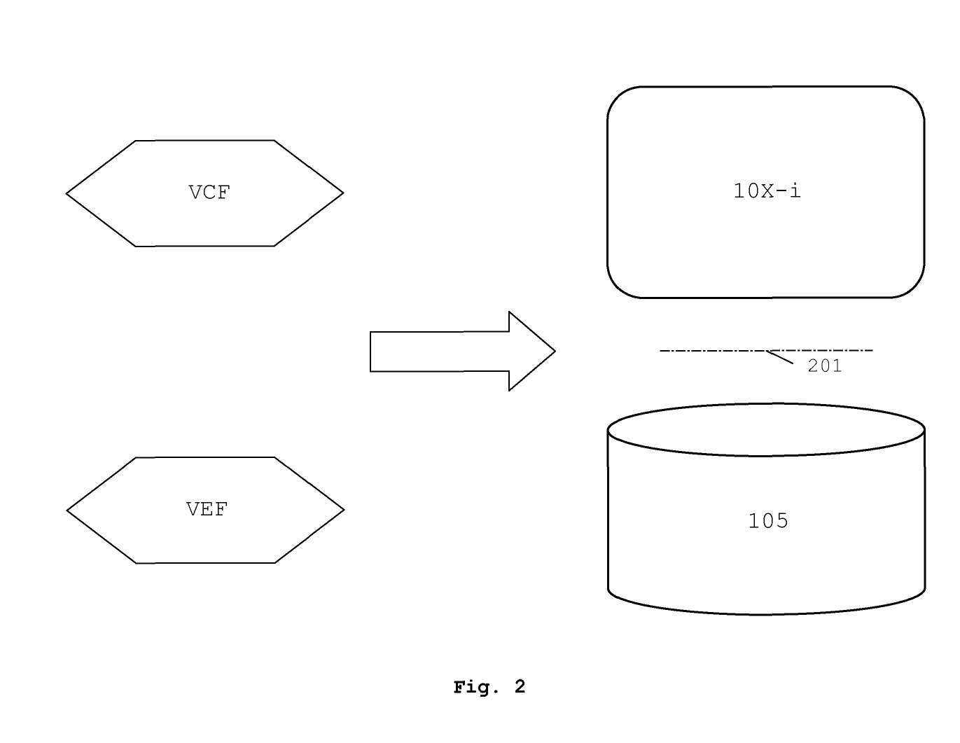

In both cases, the required adaptations are complex and can increase the development costs. In the first alternative, the developers of a first application are forced to get familiar with the particularities of further applications that could share the same data. On the other hand, the second alternative requires the intervention of database specialists. The necessary adaptations can be simplified by implementing a validation control function VCF in servers serving the applications, and a validation enforcement function VEF in the back-end storage 105, as schematically represented in FIG. 2 (the arrow in the figure illustrates implementation allocation). VCF and VEF are functional entities that preferably reside within, respectively, servers (101, 102, 103, 104) and DBS (105), and can comprise software, hardware and combinations thereof. The VCF can also utilize input information received from human operators.

In short, the VCF in a certain server (10X-i) creates, e.g. in a formal language, data description information applicable for validating data of a particular application. The description information is then downloaded from the server to a VEF in the back-end storage 105 which, in turn, compiles the description information received from other servers serving other applications, so as to build up validation rules for certain data, and enforces the validation execution at data modification. This allows performing data validation in the DBS 105, while retaining the separation between the application specific logic, and the data storage.

The information for validating a certain data is preferably downloaded from a VCF to the VEF initially, at configuration time, and can be updated when the application logic (usually referred also as business logic) changes and the validation for said data requires such an updating. As referred earlier, the VCF may be physically part of the application front end servers (i.e. servers 101, 102, 103), or handled via provisioning through an operation and maintenance server (OSS, 104). In the latest case the OSS server 104 would be considered as performing the validation control function on behalf of an application front end server (e.g. 101).

The format of the information for validating a certain data is preferably expressed, and conveyed, in a well known and inter-operable language. For example an Extended Markup Language (XML)-based language can be used. For downloading the validation description information from a VCF to the VEF in the DBS 105 an open protocol such as Simple Object Access Protocol SOAP can be used through interface 201 with the DBS 105, whenever there is a change to the business logic of a server (e.g. introducing a new application or upgrading an existing application). Other suitable protocols, such as FTP can be used to send towards the DBS 105 the “document” containing the validation description information.

As a result, the VEF does not need to contact the VCF in an application server (e.g. 102) every time a server serving an application requests to modify some data in the data repository. Another advantage of sending validation requirement information to the VEF prior to execution is that contradicting validation requirements can be detected in an early stage, e.g., before putting the whole system into operation. An example of a Contradictory validation requirements would be, for example, if an application (e.g. APP-1) requires that certain data can only be between 1 and 5, and another application (e.g. APP-2) requires the same data to be between 7 and 9.

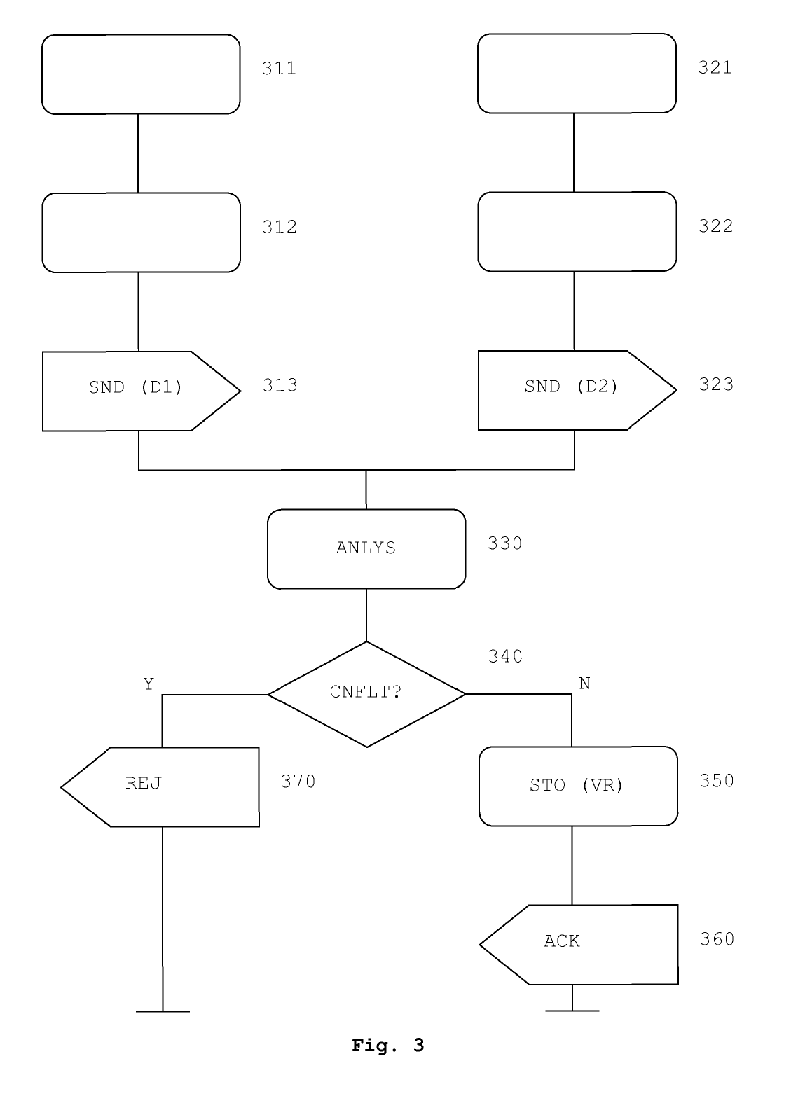

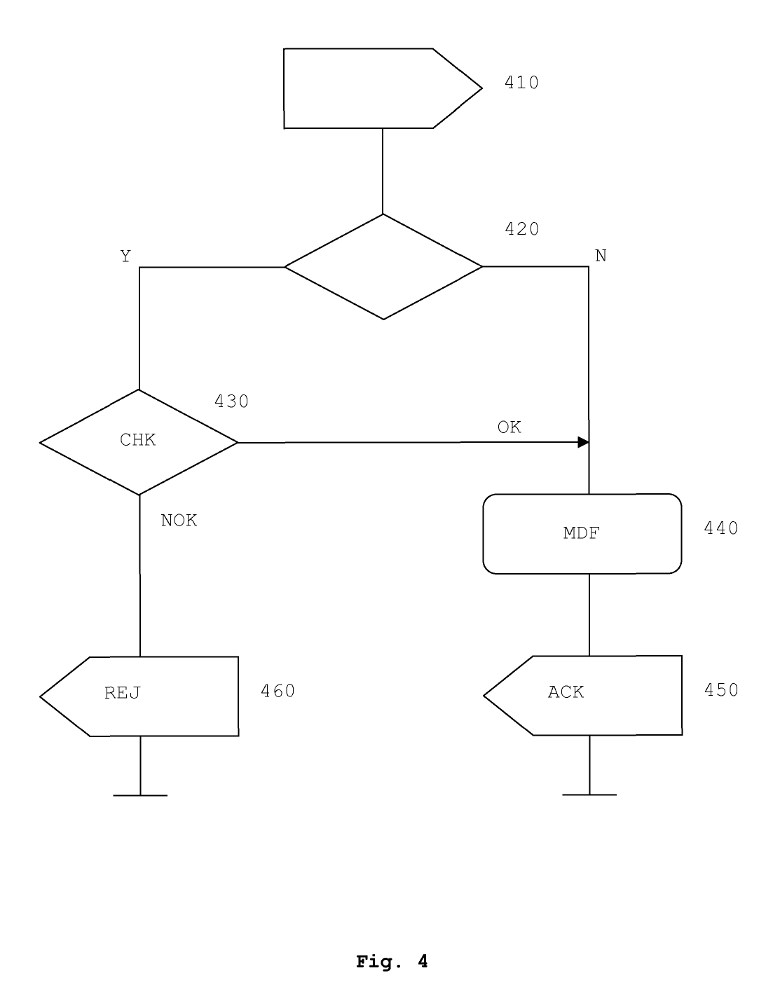

High level procedures for defining or updating the validation logic in the DBS 105, and for using it when receiving a request to modify some data stored therein, shall now be described with reference to the methods illustrated in FIGS. 3 and 4.

FIG. 3 illustrates a method for defining or updating the validation logic in the DBS 105. Step 311 represents definition, or modification, of the service logic (business/application logic) related to a first application (e.g. APP-2). The relevant data held by the first application, which contents are intended to be stored in the DBS 105, are then parsed so as to generate in step 312 description information (D1) specifying valid data contents for these data. Some examples related to possible contents of the description information (D1, D2) will be later provided. The description information is then sent in a protocol message (e.g. SOAP, LDAP, other) towards the DBS 105 in step 313.

The message of step 313 can comprise description information with regard to one or more data related to the first application APP-2, wherein the affected data are properly identified within the message. For example, if LDAP is used for accessing and modifying data in the scenario illustrated by FIG. 1, each data entry held by the DBS 105 is addressable through the so called Directory Information Tree (DIT) by one or more Distinguished Names DN, which can be used in the message of step 313 to identify the data for which validity description information is sent (e.g. coded as LDAPDN). For the sake of simplicity, it can be assumed that the description information relates to only one data entry in the DBS.

It is to be noticed that, if the process, as described so far, is not run by an server serving the application (e.g. server 102), but from an operation and maintenance server (e.g. server 104) instead, step 311 would be not necessary on said server, and step 312 could comprise a generation of description information (D1) based directly or indirectly (i.e. after post-processing) on inputs provided by an operator of the server 104.

The method continues in step 330 with an analysis by the DBS 105 based on the description information (D1) received in the message 313. The analysis can comprise: first identifying the data entry(ies) for which validity description information is received, and then checking if a validation rule, built based on previous validity information received for the same data entry(ies), is already stored in relationship with at least said data entry. If such a validation rule exists, then the method would continue by checking in step 340 if there is a conflict between the validity description information (D1) received in the message (step 313) with the validation information stored in the validation rule.

For the sake of illustration, it can be assumed that no validation rule is yet stored in relationship with the concerned data entry(es). Then the execution proceeds in DBS 105 by execution of step 350, wherein, based on the received description information for data contents of a certain identified data, it is stored a validation rule (VR) in relationship with data entry(ies) in the DBS 105 arranged to store said data. Preferably, the DBS does not have yet stored data contents in the affected entry(ies), but data entries in the DBS are already arranged to store data related to a plurality of applications. For example, its DIT has been arranged so as to make possible to address data entries to certain data identifiers that can be indicated by the servers serving the applications (101, 102, 103), and to modify and/or provide their content. A simplified embodiment (as detailed later) would comprise store (e.g. as some kind of metadata) at least relevant parts of the received description information of a certain data as information within the validation rule VR. In certain cases (different protocols and/or data identifiers used trough the interfaces 201) it can be necessary to adapt the information format and/or identifiers in the received description information, so that a common type of representation of the validation rules VRs is preferably used in the DBS 105.

The validation rule VR would then be used in the DBS 105, to determine valid data contents that can be stored in data entry(ies) assigned to store data content of the identified data, e.g. when receiving a request to modify said data from any of the servers serving the applications (101, 102, 103). For example, the validation rule can comprise information for determining allowed value ranges, and/or allowed value types, that can be stored in a data entry arranged to store data contents of said data.

Also, as will be later described, alternatively or additionally the VR can contain, based on the received validation information, information to perform a second (subsequent) data modification in the DBS upon a first successful data modification in the DBS. For example, a given data entry in the DBS can be structured into more than one sub-data elements, so that the VR states that, a certain modification in the data content of a second element in said data entry upon a successful data content modification of a first element in said data entry. The first-second (subsequent) data modification established by the validation rule VR can also be such that it establishes that, upon a successful modification of the data content of a first entry (to which the VR relates), a second (subsequent) modification is to be made upon a second entry. In the latest case, the first and second data entries can be directly linked, or being linked to the same validation rule VR, or the second data entry being identified by the validation rule VR itself. Example details concerning the embodiment described above will be later provided.

An optional acknowledgment can be sent in step 360 from the DBS 105 to the sender of the message 313 (e.g. 102, 104).

The method of the invention allows multiple applications to express, from servers serving the applications, and/or from an operation and maintenance server provisioning data for the applications, to express their respective validation requirements for the data they respectively handle, which can be shared by more of one of these applications. For example, steps 321 to 323 are equivalent steps to previously described steps 311 to 313, but performed by a server serving a second application (e.g. a server 103 serving APP-2), or from an operation and maintenance server (104) provisioning data on the DBS 105 for said second application.

For the sake of illustration, it can be assumed that steps 322 and 323 are performed in respect of the same data as steps 312 and 313, which is also handled by a second application APP-3. Namely, description information (D2) received in the DBS in step 323 specifies validation description information as required by a second server (e.g. server 103) for running the second application APP-3, and in respect to some of its related data which are also held by APP-2. Then, according to the example, the analysis of step 330 would render that a validation rule VR is already stored in relationship with a data entry addressed by the message of step 323.

The execution would then proceed to step 340 for checking for conflicts between the validation description information D2 received in step 323, and the validation information already stored in the corresponding validation rule VR. Checking step 340 would render a positive result (“N”, no conflict) if the description information D2 received in step 323, and the validation information already stored in the corresponding validation rule VR, does not contain any element which mutually exclude each other, or, in other words, which are not in contradiction because are incompatible. Step 340 can comprise checking value ranges, value types and/or other conditions specified in common in D2 and in the existing validation rule VR (including subsequent second modifications cited earlier). For example, the checking of step 340 could render a positive result (N) if a new type of condition, not previously stated in the existing validation rule VR, is defined in the received description information D2, and would render a negative result (“Y”, conflict) if, e.g., D2 defines the data content for the referred data as integer, and the validation rule establishes that valid data content is only between an enumerated sequence of valid alphabetic strings (e.g. “active”, “inactive”). For example, the checking of step 340 could render a positive result (N) if the existing validation rule VR states that valid data contents for a related entry comprise numeric values between 6 and 12 digits, and the newly received description information D2 describes valid data contents being numeric values starting with digits “34”.

If the check under 340 yields a negative result (Y), the validation rule VR would not be changed, and an optional rejection message can be sent in step 370 from the DBS 105 towards the sender of the message 323 (e.g. 103, 104). Otherwise, in step 350 the previously stored validation rule VR would be updated in the DBS 105 based on the newly received description information D2. For example, the validation rule can, after the updating, further comprise information determining a second (subsequent) modification, and/or new characterization for valid data contents stored in a certain data entry (e.g. numeric values between 6 and 12, and—new condition—starting with “34”). As before, an optional acknowledge message can be sent in step 360 from the DBS 105 towards the sender of the message 323 (e.g. 103, 104).

The interfaces 201 offered by the DBS 105 that allows servers (101 . . . 104) to obtain and/or modify data contents in the DBS can involve different technologies and protocols (such as LDAP, SQL based, XML based, etc) to access to the same or different data. In order to support these scenarios the language describing the validation rules preferably caters for eventual different representations of the same data (e.g. different data models and names according the DBS access protocol). As described earlier, this can imply the DBS 105 to adapt some received description information (D1, D2) so as to properly interpret, and adapt, the content of a validation rule VR. For example, there can be the case wherein two different applications name the same data stored in a data entry in the DBS with different names. For illustrating this, we can assume that, e.g., to refer to a number where to forward a service, server 102 can refer “Call Forwarding Number”, whilst server 103 can refer to the same data with “Forwarding Number”. An LDAP enabled database (e.g. DBS 105) can allow this kind of double-naming feature, wherein e.g. a given data entry can be named, and addressed through the DIT, via different names. The example below considers that the same attribute name is used by the servers serving the applications for referring to the same data.

Next, an example shall be given for illustrating some of the embodiments described earlier with reference to the method illustrated in FIG. 3. The example will, as cited earlier for illustration purposes, consider the intervention of: a first server 102 serving a first application APP-2 dealing with intelligent call treatment of multimedia calls established between users trough a IMS system, and of a second server 103 serving a second application APP-3 for handling SMS and/or MMS. Both applications are assumed to implement a forwarding service, wherein some data related to the forwarding service are considered as common for both applications. For example, the data entry(ies) storing destination information (“Forwarding Number”) where to alternatively redirect a terminating service for a given user (e.g. a voice call, or a received SMS or MMS), and other related service data, are considered to be shared by both applications for any served user.

In the example, the business (application) logic of each of these applications can specify the following requirements:
In APP-2, the “call forwarding number” is allowed to be anything from 6-12 digits.
In APP-2, the “call forwarding number” can only be set if the “call forwarding status” is set to “active”. The “call forwarding number” is to be removed if the call forwarding status is set to “inactive”.
In APP-3, the “forwarding number” is only allowed to be in Spain; i.e., starting with digits 34.
The served users in both applications are individually identified by their respective Mobile Subscriber ISDN numbers (MSISDN).

The information above is converted, e.g. after a parsing process on the corresponding server (102, 103, 104), into the corresponding description information (D1, D2) with regard to the respective (APP-2, APP-3) related data. As cited earlier, the way to express the description information to be sent to the DBS can be by means of a formal language, examples of which are provided next.

In the following example it is assumed that, in the description information sent to the DBS 105, the servers (102, 103) refers to the same data in the DBS with different names (e.g. “call forwarding number” in case of APP-2, and “forwarding number” in case of APP-3); however, the names referring to the same data entry could be the same in both cases, which, as referred earlier, would simplify in the DBS the building of validation rules information based on the received description information. Also, it is assumed that the addressing information identifying the concerned data for the DBS 105 are conformed according to LDAP standard addressing mechanisms. For example, data (e.g. forwarding number information) related to a user having assigned a given MSISDN number, as held by a given application, could be specified by using LDAP addressing indicators as follows: C=OP (e.g. operator identifier); OU=MSISDN; OU=Applicationld (e.g. APP-2 or APP-3).

Considering the example conditions cited above, a possible format for the description information D1 sent by, or on behalf of, the first application APP-2, e.g. on step 313, could be as described below. It is to be noticed that the notation used in the foregoing examples is provided herein just for the sake of illustrating how description information provided by, or on behalf of, the different applications, and the subsequently generated/updated validation rules, could look like. Other representation format can be apparent for the skilled person in view of the present description.

<?XML version=”1.0”?>
<!---- Validation Description information for data
related to application APP-2>
<Application>

<Access Protocol>LDAP</Access Protocol>
<Username>APP-2 </Username>

</Application>
<Ruleset Version> R1A </Ruleset Version>
<!---- The following is just a reference to the LDAP
schema used. It is not required by the protocol, but
may be of interest to the reader. It would be
optional>
<Schema url=”http:www.ericsson.net/XML/app-2_R23.xml”>
<!----- Here is the list of the validation description
information from application APP-2>
<Validation Rules>

<Rule ID=001>

| | |
|---|---|
| <Entry> <! ----- Describes the LDAP entry | > |

| | |
|---|---|
| <DN> | <!---- Describes the distinguished |

name for the object to which the rule is
applied>
OU Application= “APP-2”, MSISDN=All,
C=“OP”
</DN>
<Attribute> Forwarding Number
</Attribute>

</Entry>
<Allowed Values>

NULL
DIGITSTRING with MINSIZE = 6 and MAXSIZE
= 12

| </Allowed Values> | |
|---|---|
| <Conditional Values> | <!---- Describes the |

changes which may occur due to changes in
other data>

IF “Forwarding Number” EQ “Null” SET
Forwarding Status EQ “INACTIVE”.

</Conditional Values>

</Rule>
<Rule ID=002>

| | |
|---|---|
| <Entry> <!----- Describes the LDAP entry | > |

| | |
|---|---|
| <DN> | < !---- Describes the distinguished |

name for the object to which the rule is
applied>
OU Application= “APP-2”, MSISDN=All,
C=“OP”
</DN>
<Attribute> Forwarding Status
</Attribute>

</Entry>
<Allowed Values>

Active
Inactive

| </Allowed Values> | |
|---|---|
| <Conditional Values> | <!---- Describes the |

changes which may occur due to changes in
other data>

IF “Forwarding Status” EQ “INACTIVE” SET
Forwarding Number EQ Null.

</ Conditional Values>

</Rule>

</Validation Rules>

Considering also the example conditions cited above, a possible format for the description information D2 sent by, or on behalf of, the second application APP-3, e.g. on step 323, could be as described below.

<?XML version=”1.0”?>
<!---- Validation Description information for data
related to application APP-3>
<Application>

<Access Protocol>LDAP</Access Protocol>
<Username> APP-3 </Username>

</Application>
<Ruleset Version> R1A </Ruleset Version>
<!---- The following is just a reference to the LDAP
schema used. It is not required by the protocol, but
may be of interest to the reader. It would be
optional>
<Schema url=”http:www.ericsson.net/XML/app-3_R23.xml”>
<!----- Here is the list of the validation rules>
<Validation Rules>

<Rule ID=001>

| | |
|---|---|
| <Entry> <!----- Describes the LDAP entry | > |

| | |
|---|---|
| <DN> | <!---- Describes the distinguished |

name for the object to which the rule is
applied>
OU Application= “APP-3”, MSISDN=All,
C=“OP”
</DN>
<Attribute> Forwarding Number
</Attribute>

</Entry>
<Allowed Values>

NULL
DIGITSTRING startingwith 34

</Allowed Values>

</Rule>

</Validation Rules>

For the sake of illustration, it can be assumed that the first description information D1 is received (step 313) on the DBS 105 before than the second description information D2. An initial validation rule VR can then be stored initially in relationship with data entries storing “Forwarding Number” and/or “Forwarding Status” for all users (MSISDN=All) based on the description information D1. For example, the validation rule VR could comprise relevant parts of “Rule ID=001” and “Rule ID=002” above, as received by a server serving the first application APP-2 (102), or on behalf of, the first application:

<Attribute> Forwarding Number</Attribute>

<Allowed Values>

NULL
DIGITSTRING with MINSIZE = 6 and MAXSIZE
= 12

</Allowed Values>
<Conditional Values>

IF “Forwarding Number” EQ “Null” SET
Forwarding Status EQ “INACTIVE”.

</ Conditional Values>

<Attribute> Forwarding Status </Attribute>

<Allowed Values>

Active
Inactive

</Allowed Values>
<Conditional Values>

IF “Forwarding Status” EQ “INACTIVE” SET
Forwarding Number EQ Null.

</Conditional Values>

As the second description information D2, received afterwards (step 323) does not mutually exclude the validation information already stored in the validation rule VR, but merely adds a new condition which is not incompatible with the ones in the existing VR, then the check of step 340 would yield a positive result (N) and the validation rule VR could be updated based on the second description information received D2.

Accordingly, the validation rule VR above could further be updated with regard to allowed values for “Forwarding Number”:

<Allowed Values>

DIGITSTRING startingwith 34

</Allowed Values>

so that the resulting validation rule VR would then be as follows:

<Attribute> Forwarding Number</Attribute>

<Allowed Values>

NULL
DIGITSTRING with MINSIZE = 6 and MAXSIZE
= 12
DIGITSTRING startingwith 34

</Allowed Values>
<Conditional Values>

IF “Forwarding Number” EQ “Null” SET
Forwarding Status EQ “INACTIVE”.

</Conditional Values>

<Attribute> Forwarding Status </Attribute>

<Allowed Values>

Active
Inactive

</Allowed Values>
<Conditional Values>

IF “Forwarding Status” EQ “INACTIVE” SET
Forwarding Number EQ Null.

</Conditional Values>

The expressions above could be stored as metadata related the affected application attribute variables (“Forwarding Number”, “Forwarding Status”), so that the validation rules established therein are thus stored in relationship with the data entries in the database that are affected by them, which shall then be used to control their data content, as will be illustrated with reference to FIG. 4.

It is to be noticed that, according to different implementation alternatives, a single validation rule can comprise validation information for determining valid data contents of more than one data entry. Following the example above, the resulting expression of the validation rule exemplified above could be stored in relationship with data entries in the DBS 105 storing data of variables “Forwarding Number” and “Forwarding Status”. That could be useful if, e.g., for a given user (MSISDN) a structured data entry stores data of both variable attributes. Also, the expression of the validation rule above could be split into two validation rules: a first one related to “Forwarding Number”, and a second one related to “Forwarding Status”, which could also be suitable if, for the same user, data of these attribute variables are stored in different data entries of the DBS 105.

FIG. 4 shall now be used to describe a method for modifying the content of a data entry in the DBS 105 wherein, according to embodiments of the invention, a validation rule VR has been previously stored in relationship with at least a data entry in the DBS.

In step 410 the DBS 105 receives a request to modify the content of a data entry. In the scope of the present description, a request for data modification of a given data entry comprises: request for adding data content for said data entry (e.g. even creating new contents), requests for deleting its contents, and requests for changing its contents. If LDAP protocol is used in the interface 201 between servers 101 to 104 and the DBS 105, a request to modify the content of a data entry can be accomplished, for example, by sending towards the DBS a LDAP message indicating the LDAP “Modify” operation.

Next, on step 420, the specific logic in the DBS 105 (e.g. the VEF referred earlier) is invoked, so as to check whether a validation rule exists in relationship with the data addressed by the request 410, and to use it for validating the requested modification. As referred earlier, this can be accomplished by storing in the DBS a set of metadata making up the validation rule(s) related to one or more data identifiers (e.g. LAPDN in LDAP) that can be addressed/indicated in eventual request to modify messages from the servers, which shall then control data modifications on any data entry on the DBS arranged to store said kind of data. Alternatively, validation rules can be stored in relationship with sets of one or more individual data entries in the DBS. It is to be noticed that there can be data entries in the DBS 105 for which no validation rule is established, so, if that is the case, the execution would then proceed to step 440, wherein the requested modification would be performed by the DBS, and wherein (e.g. according to the database access protocol) an acknowledgement can be sent back to the sender of the message 410 on step 450.

If a validation rule exists in relationship with the addressed entry(ies), then the execution proceeds to step 430, wherein the requested modification is checked against the validation information established in the corresponding validation rule(s) for determining whether, according to the validation information of the validation rule, the modification shall, or shall not, be performed by the DBS 105.

Using the example cited earlier, a request to modify (410) the “Forwarding Number” of a certain user (e.g. identified by a particular MSISDN), so as to set or change its value to “(+)46123456”, would yield a negative result (NOK) in step 430. Accordingly, the modification would not be executed in the DBS 105, and a rejection could be sent back to the originator of the request in step 460. A similar request, but indicating a modification such as “34123456” would, according to the related validation rule VR be accepted and performed (step 440), as the data content requested for the attribute variable “Forwarding Number” fits with the validation information; namely: it is within the range size (“DIGITSTRING with MINSIZE=6 and MAXSIZE=12”), and its start comprise the allowed digits (“34”). Also, a similar request to modify indicating setting to “null” the content of the “Forwarding Number” of the identified user(s), would fit with the validation rule and, thus, would be accepted and executed in step 440. In this latest case, the validation information in the rule also dictates a subsequent modification on the same, or further, entry(ies) storing attribute variable “Forwarding Status” for the identified user(s), which will further cause the validation enforcing function logic in the DBS 105 to set the affected data content to the value “Inactive”.

Modern telecommunications systems, as well as other information systems, evolve towards solutions that allow providing personalized services to their users. Service personalization usually requires storing a plurality of data about the users of these systems, wherein e.g. data of a certain user can be the same for various services, or closely dependent or other data of the same user. Scattering these kind of data along servers providing said services, and/or intervening in such provision (i.e. as in monolithic servers), can be an expensive solution, and, at least, prone to errors, since maintaining data consistency among related data distributed along a plurality of separate entities is a complex task.

Furthermore, modern telecommunications systems trend to offer services that involve the intervention of a plurality of different servers, each performing a specific application, but cooperating, sometimes at different levels, in providing a service to a user. For example, providing a service to a user of a 3^{rd}. Generation (3G) telecommunications system comprising an IP Multimedia Subsystem IMS can require the intervention of, among other: a HSS (which holds subscriber data of the user), one or more SIP-ASs (which controls high-level execution aspects of the service/s), and of a PCRF (which performs policy decisions on IP data flows of the bearer/s established for the attached terminal of the user). All these nodes, cited by way of example, are servers performing specific applications that are required to use and, in certain cases, modify, data related to the served user, some of which can be common for some of the applications, but which preferably are kept consistent among these applications.

The embodiments of the invention provide the advantage of performing the data validation in a back-end storage (DBS, 105), making up a centralized data repository for a plurality of servers performing a plurality of applications, whilst retaining a separation between the pure data storage technologies and the specific application logic and minimizing design impact in commercially available DBS products. This is achieved by building validation rules, which contains validation information usable for determining valid data contents that can be stored in data entries in the centralized data repository, with description information received from the servers related to the applications.

In particular, the embodiments of the invention provide special advantages for scenarios wherein multiple applications use some data in common, which helps to prevent a first server serving a first application to cause data inconsistency affecting a second server serving a second application. Furthermore, embodiments of the invention allow the diction of contradictory data validation requirements when installing the validation logic in the DBS, for example, before run time.

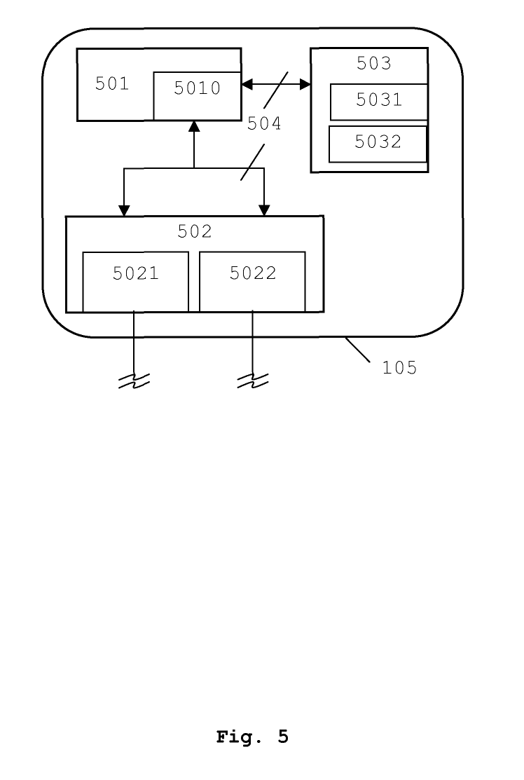

A database server DBS 105 (as well as other servers described heretofore) can, regardless of specific construction details, be considered as a functional entity comprising of one or more functional modules; each of them arranged to perform a specific (sub)function of the total functionality implemented by said entity. Once said functionality has been specified, the construction of the functional modules to build up a realization of the corresponding physical machine(s) accomplishing said apparatuses is a matter of routine work for those skilled in the art. In particular, state-of-the-art database servers are implemented by computer-based apparatuses comprising software and hardware, which realize the functional modules, and can be implemented within a single physical machine, or be distributed along various cooperating physical machines. The software comprises one or more computer programs having computer readable program code that, when executed by a computer-based apparatus makes it to behave according to a predefined manner, as determined by the specific program instructions in said programs, which can be arranged according to any of the described embodiments of the invention. Accordingly, the description given herein with reference to FIG. 5 will make reference to some functional modules of a database server 105 comprising means adapted to accomplish with any of the embodiments described heretofore, without falling into specific hardware and software construction details, which are well known by those skilled and, consequently, which are not needed to understand the invention.

The internal simplified structure of a database server 105 shall now be described with reference to FIG. 5 considering a possible implementation as a computer-based apparatus. Said structure is illustrated comprising: a processing module 501, a communications module 502, a data storage module 503 and internal communication bus 504 which allow data communication and cooperation between them. Shortly, the operation is as follows. When a signaling message is received by the communications module (e.g. messages 313, 323, 410) it transfers the relevant content to the processing module for triggering the necessary processing and, when a signaling message is to be sent, the processing module 501 requests the communications module 402 to send the message and provides it with the necessary data.

The processing module 501 can comprise one or more processors (only one processor 5010 is shown in FIG. 5) which, for example, can be arranged to work in load-sharing or active-backup mode. The operation in the DBS 105 is controlled by computer-readable program code comprising instructions that are executed by processor 5010. The execution of these instructions makes the DBS to perform as in the prior-art, and further according to embodiments of the invention described before.

Currently, the functionality of many of the nodes and servers in telecommunications and/or information systems are implemented by computer-based apparatuses. Accordingly, computer programs comprising computer-readable program codes are loaded in computer-based apparatuses of these systems causing them to behave according to a predefined manner, as determined by the respective program codes, which are in accordance to the functionality specified for the servers/nodes these apparatuses implement. Thus, those skilled in creating and/or modifying computer programs, would, without departing of the teachings of the present invention, readily apply them to create and/or modify computer programs suitable to be loaded in computer-based apparatuses, so as to make them to behave according to any of the described embodiments. In particular, computer programs can be made, or adapted, based on the teachings of this application, so as to perform any of the described embodiments and, for example, the steps of the methods described before with reference to FIGS. 3 and 4, when run on a computer-based DBS.

External communications are performed via communications module 502, illustrated in FIG. 5 as comprising two communication devices 5021 and 5022. Depending on different implementation alternatives, a communication device can be suited to accomplish with one or more than one communication types (i.e. communications according to one or more communication protocols and/or signaling interfaces). For example, communication devices 5021 and/or 5022 can be suited for communicating according to any of the communication protocols described before (LDAP, SOAP, etc).

In a computer-based database server 105, its corresponding data storage module 503 stores the data needed for their corresponding operation. The data storage module can comprise internal and/or external physical databases with storage devices for storing, among other, the data entries storing data related to its database clients (e.g. data held by servers 101, 102, 103). In the example illustrated in FIG. 5 the data storage module 503 comprises storage devices 5031 and 5032. Memory chips and magnetic or optical discs are example of data storage devices. Depending on criteria such as data access speed for certain data, storage reliability, etc, the storage module of a database server 150 can comprise one or more storage devices of the same or different kind. Data storage module 503 usually stores also the computer-readable program to be executed by processor 5010.

In the DBS 105 described with reference to FIG. 5, the communications module 502 is arranged for receiving a request to modify the content of at least a data entry stored by the storage module 503, and the processing module 501, in communication with the communications module 502, is arranged for checking a validation rule stored in relationship with said entry, and for performing or rejecting the requested modification (or for performing subsequent modifications, as determined by the validation rule) on the storage module 503 depending on said check. Further, the communications module 502 is arranged for receiving a message containing description information specifying valid data contents for a data related to an application, and the processing module 501 is arranged for storing (or updating, if proceeds) a validation rule, based on the received information, for determining valid data contents that can be stored in a data entry on the data storage module 503 arranged to store data contents of said data.

The invention has been described with respect to some exemplary embodiments in an illustrative and non-restrictive manner. Variations can be readily apparent to those of ordinary skill in the art. For this reason, the invention is to be interpreted and limited in view of the claims.

1. A method of storing data in a database server arranged to store data related to a plurality of applications, wherein a data stored for a first application is a data that is used by a second application the method comprising the step of:
receiving a message from an application server serving the first application, the message containing description information (D1) specifying valid data contents for performing a data entry with said database server,
checking (330) by the database server whether any validation rule is already stored for said data entry,
In the event there already exists a validation rule for said data entry,
maintaining unchanged by the database server the previously existing validation rule, or
updating the previously existing validation rule by adding new validation data content provided by said first application: otherwise,
In the event there is no validation rule already stored for said data entry,
storing, based on the received description information, a validation rule in relationship with the identified data entry.

2. (canceled)

3. The method of claim 1, wherein a validation rule contains information for determining at least one of:
allowed value ranges, or
allowed value types that can be stored in said entry.

4. The method of claim 1 further comprising the steps of:
receiving a request to modify the content of a data entry from a server serving any of said plurality of applications,
checking said validation rule stored in relationship with at least said data entry, and
performing the requested modification in the event said step of checking determines that there exists no conflict between said requested modification and said existing validation rule.

5. The method of claim 4, wherein the validation rule stored in relationship with said data entry contains information for determining a subsequent data content modification to be made over a second data entry upon a data content modification mode over said first data entry, and wherein the step of performing a requested modification comprises the steps of:
performing by the database server the requested data content modification over the first data entry, and
performing by the database server a subsequent data content modification over the second data entry.

6. The method of claim 1, wherein a server serving any of said plurality of applications is a node of a telecommunications system, and wherein the database server stores data entries arranged to contain data related to a plurality of subscribers of said system usable by at least said node to serve a service to at least one of these subscribers.

7. (canceled)

8. (canceled)

9. The database server of claim 14, wherein the validation rule contains information for determining at least one of:
allowed value ranges, or
allowed value types that can be stored in said entry.

10. The database server of claim 14, further comprising:
means for receiving a request to modify the content of a data entry from a server serving any of said plurality of applications,
means for checking said validation rule stored in relationship with at least said data entry, and
means for performing the requested modification in the event said means for checking determines that there exists no conflict between said requested modification and said existing validation rule

11. The database server of claim 10, wherein the validation rule stored in relationship with said data entry contains information for determining a subsequent data content modification to be made over a second data entry upon a data content modification made over said first data entry, and wherein the means for performing a requested modification comprises:
means for performing a requested data content modification over the first data entry, and
means for performing a subsequent data content modification over the second data entry.

12. The database server of claim 9, wherein a server serving any of said plurality of applications is a node of a telecommunications system, and wherein the database server stores data entries arranged to contain data related to a plurality of subscribers of said system usable by at least said node to serve a service to at least one of these subscribers.

13. (canceled)

14. A system for storing data in a database server arranged to store data related to a plurality of applications, wherein a data stored for a first application is a data that is used by a second application, comprising:
means for receiving a message from an application server serving the first application, the message containing description information specifying valid data contents for performing a data entry with said database server,
means for checking by the database server whether any validation rule is already stored for said data; and
In the event there already exists a validation rule for said data entry,
means for updating the previously existing validation rule by adding new validation data content provided by said first application; otherwise,
In the event there is no validation rule already stored for said data entry,
means for storing based on the received description information, a validation rule in relationship with the identified data entry.

15. A method for storing data associated with a plurality of applications within a telecommunication network wherein said data are stored within a database server node and said plurality of applications are provided by one or more application server node communicably coupled to said database server node, said method comprising the steps of:
receiving a first message from a first application, said first message including first description information specifying the requirements for validating a particular data entry associated with said first application;
storing said description information with said database server node for serving said first application;
receiving a second message from a second application, said second message including second description information specifying the requirements for validating a particular data entry associated with said second application;
updating said description information already stored with said database server to add said second description information;
in response to receiving a request from either said first application or second application for making a data entry into said database server,
performing said requested data entry if said requested data entry complies with requirements associated with said updated description.

16. The method of claim 15 where said first message further includes a particular data entry requested by said first application.

17. The method of claim 15 wherein said step of updating said description information already stored with said database server to add said second description information further comprises the step of checking whether said second description information does not conflict with said already stored description information.

18. The method of claim 17 wherein such conflict includes mutually exclusive conditions required between said stored description information and said second description information.

19. The method of claim 15 wherein said telecommunication network includes an IMS network and said first application includes a call forwarding feature.

20. The method of claim 19 wherein said data entry includes MSISDN number associated with a mobile subscriber within said IMS network.

21. The method of claim 20 wherein said second application includes a SMS feature for said MSISDN number.
